(19) United States
(12) Patent Application Publication
(10) Pub. No.: US 2026/0349459 A1
(43) Pub. Date: Nov. 5, 2026

(54) SIGNAL TRANSMISSION CIRCUIT, CIRCUIT BOARD, AND ELECTRONIC DEVICE

(71) Applicant: CANAAN CREATIVE (SH) CO., LTD., SHANGHAI (CN)

(72) Inventors: Fuxing LIU, Beijing (CN); Jiakun MA, Beijing (CN); Hongbin MAO, Beijing (CN); Nangeng ZHANG, Beijing (CN)

(21) Appl. No.: 19/122,094

(22) PCT Filed: Oct. 20, 2023
(86) PCT No.: PCT/CN2023/125740

§ 371 Date: Apr. 17, 2025

(30) Foreign Application Priority Data
Oct. 20, 2022 (CN) 202211284348.9
Nov. 22, 2022 (CN) 202211469240.7

(51) Int. Cl. G05F 1/46

(52) U.S. Cl. CPC G05F 1/46

(57) ABSTRACT

The present application provides in its embodiments a signal transmission circuit, a circuit board, and an electronic device. The signal transmission circuit comprises: N stages of working circuits connected in series, wherein each working circuit comprises at least one working chip, a first stage of working circuit is connected to a first system voltage, and a N stage of working circuit is connected to a second system voltage; and N stages of signal transmission power supply circuits corresponding one-to-one to the N stages of working circuits, wherein the signal transmission power supply circuits each comprises at least one power supply chip, and is configured to provide a signal transmission voltage for the working chip in at least one working circuits, wherein N is an integer greater than 1. The technical solution in the embodiments of the present application can enable normal signal transmission for working chips in second to N^{th} stages of working circuits.

### CROSS REFERENCE TO RELATED APPLICATIONS

This present application is a U.S. National Stage Application of International Application No. PCT/CN 2023/125740, filed on Oct. 20, 2023, which claims priority to and benefits of Chinese Patent Application No. 202211291965.1, entitled “WORKING ASSEMBLY AND ELECTRONIC DEVICE”, filed with the China Patent Office on Oct. 20, 2022, and Chinese Patent Application No. 202211415822.7, entitled “CIRCUIT BOARD AND WORKING ASSEMBLY”, filed with the China Patent Office on Nov. 11, 2022. The entire contents of all of the above-identified applications are incorporated herein by reference.

### TECHNICAL FIELD

The present application relates to the technical field of signal transmission, and in particular to a signal transmission circuit, a circuit board, and an electronic device comprising the same.

### BACKGROUND

In the related art, a hashrate board generally integrates a plurality of chips on the same circuit board to enhance computing power. In order to achieve high efficiency and energy saving, a computing unit is usually composed of a plurality of computing chips. The core voltage power supply of the computing chips mostly adopts a power supply in series mode.

### SUMMARY

The present application provides in its embodiments a signal transmission circuit, a circuit board, and an electronic device.

As a first aspect of the embodiments of the present application, the present application provides in its embodiments a signal transmission circuit, including: N stages of working circuits connected in series, each including at least one working chip, wherein a first stage of working circuit is connected to a first system voltage, the N^{th} stage of working circuit is connected to a second system voltage, the second system voltage is higher than the first system voltage, and the voltage difference between the second system voltage and the first system voltage provides a core working voltage for each stage of working circuit; and N stages of signal transmission power supply circuits corresponding one-to-one to the N stages of working circuits, wherein the signal transmission power supply circuits each includes at least one power supply chip, and is configured to provide a signal transmission voltage for the working chip in at least one working circuits, wherein N is an integer greater than 1. The core working voltage is the primary voltage for the chip, such as the voltage used to provide computation to the chip.

In one implementation, a high voltage of signal transmission inputted by the working chip is greater than a threshold high voltage, a low voltage of signal transmission inputted by the working chip is less than a threshold low voltage, and the core working voltage of the working chip is less than a difference between the signal transmission voltage and the threshold high voltage.

In one implementation, the working chip includes at least one power supply domain for providing power supply for signal transmission to the working chip.

In one implementation, the N stages of working circuits include at least one first working chip, the first working chip includes a first power supply domain and a second power supply domain, and the signal transmission voltage inputted by the first power supply domain of the first working chip and the signal transmission voltage inputted by the second power supply domain are both provided by the same signal transmission power supply circuit.

In one implementation, the first power supply domain and the second power supply domain of the first working chip are connected inside and outside of the first working chip through a transmission line.

In one implementation, working chips in the N stages of working circuits are all configured as first working chips.

In one implementation, the N stages of working circuits further include at least one second working chip, the second working chip includes a third power supply domain and a fourth power supply domain, and the signal transmission voltage inputted by the third power supply domain of the second working chip and the signal transmission voltage inputted by the fourth power supply domain are provided by different signal transmission power supply circuits.

In one implementation, the signal transmission voltage inputted by the third power supply domain of the second working chip is provided by a previous one stage of signal transmission power supply circuit, and the signal transmission voltage inputted by the fourth power supply domain of the second working chip is provided by a corresponding stage of signal transmission power supply circuit.

In one implementation, working chips in the first stage of working circuit are all configured as first working chips, and the second to N^{th} stages of working circuits each includes at least one first working chip and at least one second working chip.

In one implementation, the working chips in the same stage of working circuit have the same reference voltage, and the working chips in two adjacent stages of working circuits have different reference voltages.

In one implementation, reference voltages of the working chips in the (i+1)^{th} stage of working circuit are all derived from the i^{th} stage of working circuit, wherein i is an integer greater than or equal to 1.

In one implementation, a low level voltage outputted by the i^{th} stage of working circuit is equal to a low level voltage inputted by the (i+1)^{th} stage of working circuit, and a low level voltage outputted by the (i+1)^{th} stage of working circuit is greater than the low level voltage inputted by the (i+1)^{th} stage of working circuit; and a high level voltage inputted by the i^{th} stage of working circuit is equal to a high level voltage inputted by the (i+1)^{th} stage of working circuit, and a high level voltage outputted by the (i+1)^{th} stage of working circuit is greater than the high level voltage inputted by the (i+1)^{th} stage of working circuit.

In one implementation, the signal transmission circuit further includes: a signal voltage conversion circuit configured to send a control board signal sent by a control board to the N stages of working circuits or send working circuit signals sent by the N stages of working circuits to the control board.

In one implementation, the first stage of working circuit is configured to receive the control board signal, and the signal voltage conversion circuit is configured to send a working circuit signal of the N^{th} stage of working circuit to the control board.

In one implementation, the signal transmission circuit further includes: pull-up resistors connected in series between two adjacent stages of working circuits and configured to convert a first high level voltage outputted by the i^{th} stage of working circuit into a second high level voltage inputted by the (i+1)^{th} stage of working circuit, wherein the second high-level voltage is higher than the first high-level voltage, and i is a positive integer greater than or equal to 1 and less than or equal to N−1.

In one implementation, a third high level voltage outputted by the (i+1)^{th} stage of working circuit is equal to the second high level voltage inputted by the (i+1)^{th} stage of working circuit.

In one implementation, a first low level voltage outputted by the i^{th} stage of working circuit is equal to a second low level voltage inputted by the (i+1)^{th} stage of working circuit, and a second low level voltage outputted by the (i+1)^{th} stage of working circuit is greater than the second low level voltage inputted by the (i+1)^{th} stage of working circuit.

In one implementation, working chips in the same stage of working circuit have the same reference voltage, and working chips in two adjacent stages of working circuits have different reference voltages.

In one implementation, a first reference voltage outputted by the i^{th} stage of working circuit is less than a second reference voltage inputted by the (i+1)^{th} stage of working circuit.

In one implementation, a difference between the first high level voltage and a corresponding first reference voltage is equal to a difference between the second high level voltage and a corresponding second reference voltage.

In one implementation, reference voltages of the working chips in the (i+1)^{th} stage of working circuit are all derived from the i^{th} stage of working circuit, and reference voltages of the working chips in the first stage of working circuit are derived from the first system voltage.

In one implementation, the signal transmission circuit further includes: a signal voltage conversion circuit, wherein a first input/output terminals of the signal voltage conversion circuit is connected to the N^{th} stage of working circuit, a second input/output terminals of the signal voltage conversion circuit is connected to the control board, and the signal voltage conversion circuit is configured to perform voltage conversion on a control board signal sent by a control board and then send the converted control board signal to the N^{th} stage of working circuit; or the signal voltage conversion circuit is configured to perform voltage conversion on a working circuit signal sent by the N^{th} stage of working circuit and then send the converted working circuit signal to the control board.

In one implementation, the first stage of working circuit is configured to receive the control board signal, and the signal voltage conversion circuit is configured to send a working circuit signal of the N^{th} stage of working circuit to the control board.

As a second aspect of the embodiments of the present application, the present application provides in its embodiments a circuit board including the signal transmission circuit according to any one of the above-mentioned implementations of the present application.

As a third aspect of the embodiments of the present application, the present application provides in its embodiments an electronic device including the circuit board according to the above-mentioned second aspect of the present application.

The above summary is for the purpose of illustration only and is not intended to be limiting in any way. In addition to the schematic aspects, implementations and features described above, further aspects, implementations and features of the present application will readily apparent by referring to the accompanying drawings and the following detailed description.

### BRIEF DESCRIPTION OF THE DRAWINGS

In the drawings, unless otherwise specified, the same reference numerals refer to identical or similar parts or elements throughout the drawings. These drawings are not necessarily drawn to scale. It should be understood that these drawings only depict some implementations disclosed in accordance with the present application and thus should not be considered as limiting the scope of the present application.

FIG. 1 shows a circuit diagram of a signal transmission circuit according to an embodiment of the present application;

FIG. 2A shows another circuit diagram of a signal transmission circuit according to an embodiment of the present application;

FIG. 2B shows yet another circuit diagram of a signal transmission circuit according to an embodiment of the present application;

FIG. 3 shows a sequence diagram of input and output signals of a signal transmission circuit according to an embodiment of the present application;

FIG. 4 shows a circuit diagram of a signal transmission circuit according to another embodiment of the present application;

FIG. 5 shows a sequence diagram of input and output signals of a signal transmission circuit according to another embodiment of the present application;

FIG. 6 shows a circuit diagram of a signal transmission circuit according to yet another embodiment of the present application; and

FIG. 7 shows a sequence diagram of input and output signals of a signal transmission circuit according to yet another embodiment of the present application.

### NOTES OF REFERENCE NUMERALS

10: signal transmission circuit;
100: working circuit; 110: working chip; 111: first power supply domain; 112: second power supply domain; 113: third power supply domain; 114: fourth power supply domain; 200: first system voltage; 300: second system voltage; 400: signal transmission power supply circuit; 410: power supply chip; 500: pull-up resistor;
20: control board.

### DETAILED DESCRIPTION

Hereinafter, certain exemplary embodiments are described briefly. As those skilled in the art will recognize, the described embodiments may be modified in various different ways without departing from the spirit or scope of the present application. Accordingly, the drawings and description are to be regarded as illustrative in nature and not restrictive.

By adopting the technical solutions disclosed herein, the embodiments of the present application enable normal signal transmission for the working chips in the second to N^{th} stages of working circuits, thus achieving normal signal transmission for the chips in multiple working circuits.

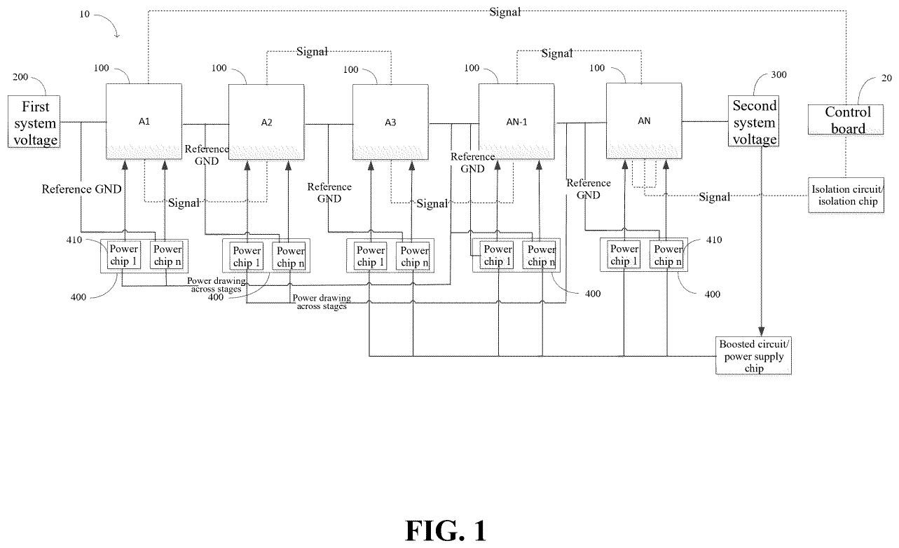

Hereinafter, a signal transmission circuit 10 according to the embodiments of the first aspect of the present application will be described with reference to FIGS. 1 to 7.

FIG. 1 shows a circuit diagram of a signal transmission circuit 10 according to an embodiment of the present application. As shown in FIG. 1, the signal transmission circuit 10 includes N stages of working circuits 100 connected in series and N stages of signal transmission power supply circuits 400. For ease of description, as shown in FIG. 1, the N stages of working circuits 100 are numbered A₁, A₂, A₃, . . . , A_{N-1}, and AN, respectively, wherein N is an integer greater than 1.

Each working circuit 100 includes at least one working chip 110. The working chip 110 may be various computing chips or control chips, etc., to realize corresponding core functions such as computing functions or control functions. In the case where a plurality of working chips 110 are included in the same stage of working circuit 100, the plurality of working chips 110 may be connected in parallel. For example, each stage of working circuit 100 may include three working chips 110, and the three working chips 110 in the same stage of working circuit 100 are connected in parallel. The N stages of working circuits 100 are connected in series.

Optionally, the number of working chips 110 in each stage of working circuit 100 may be equal or unequal. It can be understood that the number of working chips 110 in each stage of working circuits 100 can be specifically configured according to actual needs to meet practical applications.

By way of example, for the working chips 110 in the current stage of working circuit 100, calculations are performed according to an input signal of the current stage of working circuit 100, and an output signal of the current stage of working circuit 100 is generated according to calculation results. The input signal of the current stage of working circuit 100 is derived from an output signal of a previous one stage of working circuit 100, and the output signal of the current stage of working circuit 100 is outputted to the next one stage of working circuit 100.

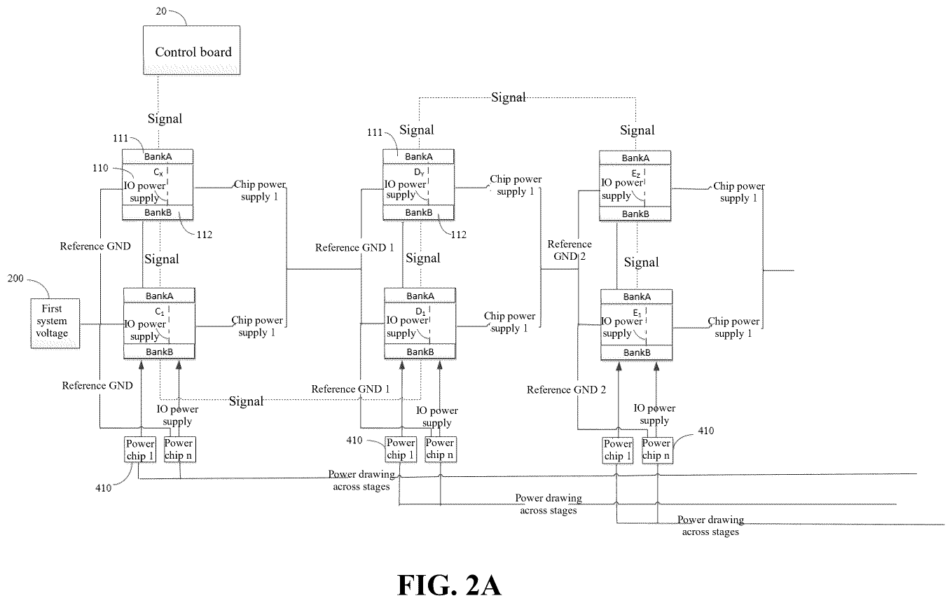

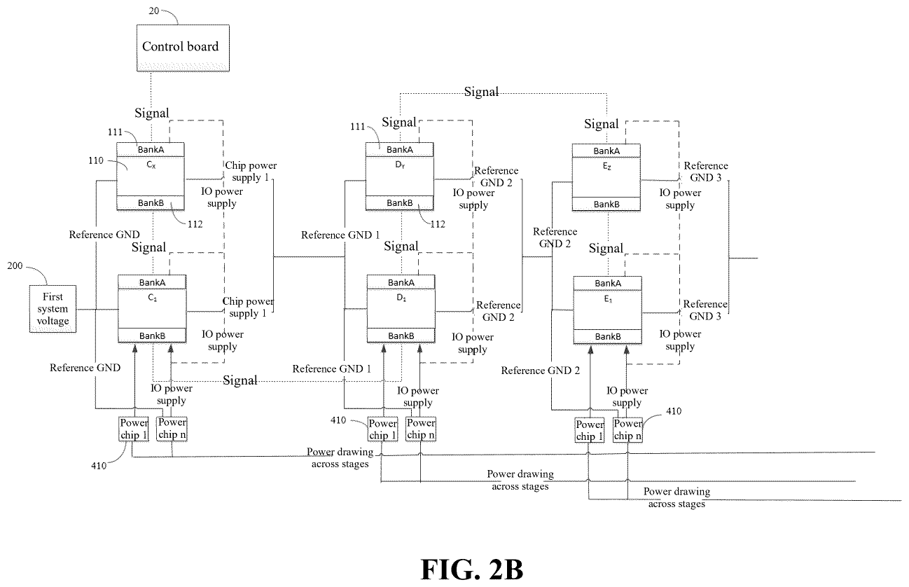

Further, with reference to FIGS. 1 and 2A, the first stage of working circuit 100A₁ is connected to a first system voltage 200, and the N^{th} stage of working circuit 100A_{N} is connected to a second system voltage 300. The second system voltage 300 is higher than the first system voltage 200. A voltage difference between the second system voltage 300 and the first system voltage 200 provides a core working voltage for each stage of working circuit 100.

By way of example, the N stages of working circuits 100 are connected in series between the first system voltage 200 and the second system voltage 300. The first system voltage 200 may be a system ground voltage, and the second system voltage 300 may be a system power supply voltage. For example, when the N stages of working circuits 100 are applied to an electronic device, the first system voltage 200 may be provided by a ground terminal of the electronic device, and the second system voltage 300 may be provided by a power source connected to by the electronic device.

Here, it should be noted that this embodiment does not define the direction in which the signals of the N stages of working circuits 100 are transmitted. For example, the signal can be transmitted from A₁ to A_{N} and, alternatively, can be transmitted from A_{N} to A₁.

The N stages of signal transmission power supply circuits 400 correspond one-to-one to the N stages of working circuits 100. Each of the signal transmission power supply circuits includes at least one power supply chip 410, which is configured to provide a signal transmission voltage for the working chip 110 in at least one working circuit 100.

By way of example, the signal transmission voltage may provide an auxiliary function voltage for special functions other than the core functions of the working circuits 100, such as serving as an input/output voltage or a clock signal voltage of the working circuits 100. For ease of description, the N stages of signal transmission power supply circuits 400 are numbered B₁, B₂, B₃, . . . , B_{N-1}, BN, respectively, wherein B₁ is at least connected to A₁ to provide A₁ with at least one signal transmission voltage, B₂ is at least connected to A₂ to provide A₂ with at least one signal transmission voltage, . . . , and BN is at least connected to A_{N} to provide A_{N} with at least one signal transmission voltage.

Based on the above description, it can be known that for each stage of working circuit 100, its power supply terminal may include a power supply terminal in a series circuit, and may also include a power supply terminal for signal transmission voltage, and there may be a plurality of power supply terminals for signal transmission voltage; its ground terminal is its series port close to a connection terminal of the first system voltage 200.

Wherein, a high voltage of signal transmission inputted by the working chip 110 is greater than a threshold high voltage, a low voltage of signal transmission inputted by the working chip 110 is less than a threshold low voltage, and the core working voltage of the working chip 110 is less than a difference between the signal transmission voltage and the threshold high voltage.

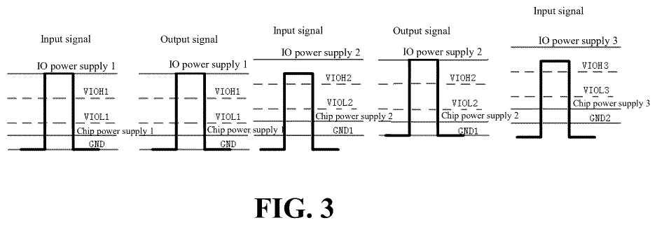

For example, in the examples of FIGS. 2A-3, the stages of working circuits 100 may include a plurality of working chips 110. Taking the first three stages of working circuits 100 as an example, the plurality of working chips 110 in the first stage of working circuit 100 are numbered C₁-C_{X}, respectively, the plurality of working chips 110 in the second stage of working circuit 100 are numbered D₁-D_{Y}, respectively, and the plurality of working chips 110 in the third stage of working circuit 100 are numbered E₁-E_{Z}, respectively, wherein X, Y, and Z are all integers greater than 1.

The signal levels of C₁-C_{X} have the same ground reference point. If they are powered by the same power supply chip 410, the high signal transmission voltages (IO power supply 1) of C₁-C_{X} are the same, the low signal transmission voltages (GND) of C₁-C_{X} are the same, the high-level voltages VIOH1 of C₁-C_{X} are the same, and the low voltages VIOL1 of C₁-C_{X} are the same. The signal levels of D₁-D_{Y} have the same ground reference point. If they are powered by the same power supply chip 410, the high signal transmission voltages (IO supply 2) of D₁-D_{Y} are the same, the low signal transmission voltages (GND1) of D₁-D_{Y} are the same, the high-level voltages VIOH2 of D₁-D_{Y} are the same, and the low voltages VIOL2 of D₁-D_{Y} are the same. Similarly, the signal levels of E₁-E_{z} have the same ground reference point. If they are powered by the same power supply chip 410, the high signal transmission voltages (IO supply 3) of E₁-E_{Z}are the same, the low signal transmission voltages (GND2) of E₁-E_{Z} are the same, the high-level voltages VIOH3 of E₁-E_{Z} are the same, and the low voltages VIOL3 of E₁-E_{Z} are the same.

With reference to FIG. 3, the signals of C₁-C_{X} are transmitted normally, and their input and output signals have equal or similar amplitudes. When a signal is transmitted across stages, since the signal levels of the working chips 110 in the first stage of working circuit 100 and the second stage of working circuit 100 have different ground reference points, the input signals of D₁-D_{Y} are shown in FIG. 3. The high voltage of signal transmission inputted by D₁-D_{Y} is IO power supply 2, the D₁-D_{Y} threshold high voltage is VIOH2, the D₁-D_{Y} threshold low voltage is VIOL2, the core working voltage of D₁-D_{Y} is chip power supply 2, and the reference voltage of D₁-D_{Y} is GND1, wherein the voltage of the IO power supply 2 is higher than the threshold high voltage VIOH2, and the voltage of the GND is lower than the threshold low voltage VIOL2.

Since the signal high level amplitude is greater than the threshold high voltage VIOH2, the input signals of D₁-D_{Y} are normal signals 1, and since the signal low level is less than the threshold high voltage VIOL2, the input signals of D₁-D_{Y} are normal signals 0. Since the power supply and ground reference points for the signal levels of D₁-D_{Y} are different from those of C₁-C_{X}, the output of D₁-D_{Y} must satisfy the full-scale output of the power supply stages of D₁-D_{Y}. The same applies to E₁-E_{Z}.

According to the signal transmission circuit 10 of the embodiments of the present application, the technical solutions of the embodiments of the present application can enable normal signal transmission for the working chips 110 of the second to N^{th} stages of working circuits, thus achieving normal signal transmission for the chips of multiple working circuits 100.

In one implementation, as shown in FIGS. 2A and 2B, the working chip 110 includes at least one power supply domain for providing power supply for signal transmission to the working chip 110. That is, the working chip 110 may include one power supply domain for providing signal transmission power supply; or the working chip 110 may also include a plurality of power supply domains for providing signal transmission power supply.

By way of example, when the working chip 110 has a plurality of power supply domains, the power supply domains can be switched on and off independently. For example, when a certain power supply domain does not need to work, the power supply domain can be shut down to reduce power consumption. In addition, different power supply domains in the same working chip 110 may use the same power supply voltage; or different power supply domains in the same working chip 110 may use different power supply voltages, so that a lower voltage can lead to lower power consumption.

In one implementation, with reference to FIGS. 1-3, the N stages of working circuits 100 includes at least one first working chip, the first working chip includes a first power supply domain 111 and a second power supply domain 112, and the signal transmission voltage inputted by the first power supply domain 111 of the first working chip and the signal transmission voltage inputted by the second power supply domain 112 are both provided by the same signal transmission power supply circuit 400, that is to say, the first power supply domain 111 and the second power supply domain 112 are powered by the same IO.

By way of example, the first power supply domain 111 and the second power supply domain 112 may be used for signal transmission. The signal transmission voltage inputted by the first power supply domain 111 and the signal transmission voltage inputted by the second power supply domain 112 can both be provided by the signal transmission power supply circuit 400 corresponding to the current stage of working circuit 100. The signal transmission power supply circuit 400 at the same stage as the first working chip is connected to the first working chip, thereby providing the signal transmission voltage for the first power supply domain 111 and the second power supply domain 112. At this time, the first power supply domain 111 and the second power supply domain 112 adopt the same power supply chip 410 to output power.

In one implementation, as shown in FIGS. 2-4, the first power supply domain 111 and the second power supply domain 112 of the first working chip are connected inside and outside of the first working chip through a transmission line. That is to say, the first power supply domain 111 and the second power supply domain 112 can be connected internally to the first working chip through a transmission line, and at this time, the transmission line can be located inside the first working chip (as shown in FIG. 2A); or the first power supply domain 111 and the second power supply domain 112 can be connected externally to the first working chip through a transmission line, and at this time, the transmission line can be located outside the first working chip (as shown in FIG. 2B). The transmission line may be a voltage transmission line.

By way of example, the signal transmission power supply circuit 400 may include a first transmission line and a second transmission line. The first transmission line may be connected between the power supply chip 410 and the working chip 110, and the second transmission line may be connected between the first power supply domain 111 and the second power supply domain 112 of the first working chip. The second transmission line may be located internal or externally to the first working chip. Therefore, on the one hand, the first power supply domain 111 and the second power supply domain 112 can enable signal transmission through a transmission line; on the other hand, the location of the transmission line can be flexibly selected according to actual needs, that is, the way in which the first power supply domain 111 and the second power supply domain 112 are connected can be selected according to actual needs, so as to better meet actual needs.

It can be understood by those skilled in the art that the transmission line may be a voltage transmission line or a signal transmission line, and the type of the transmission line is selected according to actual usage in the circuit. It should be noted that the number of transmission lines in the drawings of the present invention is only for schematic illustration, and both the number of the voltage transmission lines and the number of the signal transmission lines are not limited to 1.

In one implementation, all of the working chips 110 in the N stages of working circuits 100 are configured as first working chips. At this time, B₁ is connected to A₁ to provide a signal transmission voltage for the first power supply domain 111 and the second power supply domain 112 of the first working chip in the first stage of working circuit 100; B₂ is connected to A₂ to provide a signal transmission voltage for the first power supply domain 111 and the second power supply domain 112 of the first working chip in the second stage of working circuit 100 ; . . . ; B_{N} is connected to AN to provide a signal transmission voltage for the first power supply domain 111 and the second power supply domain 112 of the first working chip in the N^{th} stage of working circuit 100. With this arrangement, while ensuring normal signal transmission for chips in a plurality of working circuits 100, the circuit connections of the signal transmission circuit 10 remain simple.

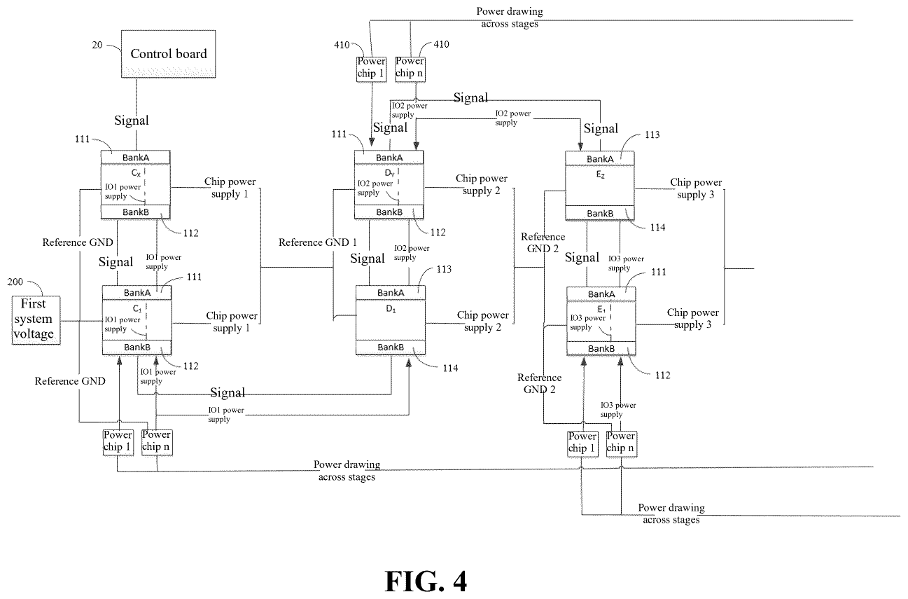

In one implementation, with reference to FIG. 4, the N stages of working circuits 100 further include at least one second working chip, the second working chip includes a third power supply domain 113 and a fourth power supply domain 114, and the signal transmission voltage inputted by the third power supply domain 113 of the second working chip and the signal transmission voltage inputted by the fourth power supply domain 114 are provided by different signal transmission power supply circuits 400, that is to say, the third power supply domain 113 and the fourth power supply domain 114 are powered by different IOs. For example, it is possible that one of the third power supply domain 113 and the fourth power supply domain 114 is provided by the signal transmission power supply circuit 400 corresponding to the current stage of working circuit 100, and the other of the third power supply domain 113 and the fourth power supply domain 114 is provided by the signal transmission power supply circuit 400 corresponding to another stage of working circuit 100; or both the third power supply domain 113 and the fourth power supply domain 114 are provided by the signal transmission power supply circuit 400 corresponding to another stage of working circuit 100, and the third power supply domain 113 and the fourth power supply domain 114 adopt different power supply chips 410 to output power.

Further, with reference to FIG. 4, the signal transmission voltage inputted by the third power supply domain 113 of the second working chip is provided by a previous one stage of signal transmission power supply circuit 400, and the signal transmission voltage inputted by the fourth power supply domain 114 of the second working chip is provided by a corresponding stage of signal transmission power supply circuit 400. For example, when the second working chip is located in the second stage of working circuit 100, the signal transmission voltage inputted by the third power supply domain 113 of the second working chip is provided by the first stage of signal transmission power supply circuit 400, and the signal transmission voltage inputted by the fourth power supply domain 114 of the second working chip is provided by the second stage of signal transmission power supply circuit 400.

Optionally, the signal transmission circuit 10 may further include an isolation circuit/isolation chip. Signals may or may not pass through the isolation circuit/isolation chip. When signals do not pass through the isolation circuit/isolation chip, they can be transmitted to A₁ externally or internally through A_{N} and then transmitted from A₁ to the control board.

As shown in FIGS. 2A, 2B and 4, the signal transmission path from A_{N} to A₁ and to the control board is indicated by the signal dotted line in the figures. In addition, the signal transmission between adjacent working chips can be transmitted by a signal line or other suitable ways, which are not limited here.

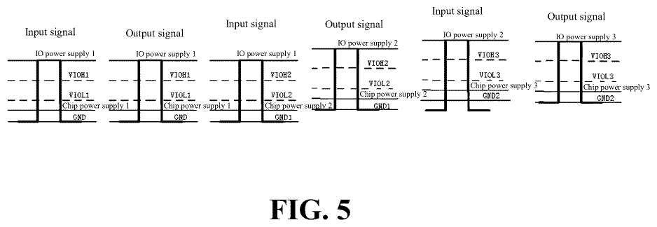

In one implementation, with reference to FIGS. 4 and 5, the working chips 110 in the first stage of working circuit 100 are all configured as first working chips, and the second to N^{th} stages of working circuits 100 each includes at least one first working chip and at least one second working chip. For example, in the examples of FIGS. 4 and 5, the stages of working circuit 100 all include two working chips 110. The two working chips 110 in the first stage of working circuit 100 are both first working chips, and the two working chips 110 in the second to N^{th} stages are the first working chip and the second working chip, respectively. The output of the first stage of working circuit 100 and the input of the second stage of working circuit 100 share the same voltage and power supply for the high level, the output of the second stage of working circuit 100 and the input high level of the third stage of working circuit 100 share the same voltage and power supply for the high level, . . . , the output of the (N-1)^{th} stage of working circuit 100 and the input high level of the N^{th} stage of working circuit 100 share the same voltage and power supply for the high level. In this way, it can also enable the full-scale output of the power supply stages of the chips from the second to the N^{th} stage of working circuits 100.

For illustrative purposes, FIG. 4 shows that the stages of working circuit 100 all includes two working chips 110. However, after reading the technical solution of the present application, a person of ordinary skill in the art would clearly understand that the solution can be applied to technical solutions involving other quantities of working chips 110, and such applications also fall within the scope of protection of this application.

In one implementation, the working chips 110 in the same stage of working circuit 100 have the same reference voltage, and the working chips 110 in two adjacent stages of working circuits 100 have different reference voltages.

By way of example, C₁-C_{X} have the same reference voltage, D₁-D_{Y} have the same reference voltage, and E₁-E_{Z} have the same reference voltage; however, the reference voltages of C₁-C_{X}, D₁-D_{Y} and E₁-E_{Z} are different from each other. Reference voltages of the working chips 110 in the (i+1)^{th} stage of working circuit 100 are all derived from the i^{th} stage of working circuit 100, wherein i is an integer greater than or equal to 1. For example, reference voltages of the working chips 110 in the second stage of working circuit 100 are all derived from the first stage of working circuit 100, reference voltages of the working chip 110 in the third stage of working circuit 100 are all derived from the second stage of working circuit 100, . . . , reference voltages of the working chips 110 in the N^{th} stage of working circuit 100 are all derived from the (N-1)^{th} stage of working circuit 100. Reference voltages of the working chips 110 in the first stage of working circuit 100 may be derived from the first system voltage 200.

In one implementation, with reference to FIG. 3, a low level voltage outputted by the i^{th} stage of working circuit 100 is equal to a low level voltage inputted by the (i+1)^{th} stage of working circuit 100, and a low level voltage outputted by the (i+1)^{th} stage of working circuit 100 is greater than the low level voltage inputted by the (i+1)^{th} stage of working circuit 100. A high level voltage inputted by the i^{th} stage of working circuit 100 is equal to a high level voltage inputted by the (i+1)^{th} stage of working circuit 100, and a high level voltage outputted by the (i+1)^{th} stage of working circuit 100 is greater than the high level voltage inputted by the (i+1)^{th} stage of working circuit 100.

By way of example, the signal waveform outputted by the i^{th} stage of working circuit 100 and the signal waveform inputted by the (i+1)^{th} stage of working circuit 100 may be the same. For example, in conjunction with FIG. 3, in the first three stages of the working circuit 100, the signal waveform outputted by the first stage of the working circuit 100 is the same as the signal waveform inputted by the second stage of the working circuit 100, wherein the low level voltage outputted by the first stage of working circuit 100 is equal to the low level voltage inputted by the second stage of working circuit 100, and the high level voltage outputted by the first stage of working circuit 100 is equal to the high level voltage inputted by the second stage of working circuit 100. The signal waveform outputted by the second stage of working circuit 100 is the same as the signal waveform inputted by the third stage of working circuit 100, wherein the low level voltage outputted by the second stage of working circuit 100 is equal to the low level voltage inputted by the third stage of working circuit 100, and the high level voltage outputted by the second stage of working circuit 100 is equal to the high level voltage inputted by the third stage of working circuit 100.

In one implementation, the signal transmission circuit 10 further includes a signal voltage conversion circuit configured to send a control board signal sent by a control board 20 to the N stages of working circuits 100. Specifically, the control board 20 sends its own control board signal to the signal voltage conversion circuit, and the signal voltage conversion circuit can perform voltage conversion on the control board signal, and then send the converted control board signal to the N stages of working circuits 100; the N stages of working circuits 100 work according to the control board signal after voltage conversion, and generates a working circuit signal according to a final working result (such as a calculation result), and sends the working circuit signal to the control board 20.

By way of example, the control board 20 sends a control board signal to the signal voltage conversion circuit, the signal voltage conversion circuit is used to send the voltage-converted control board signal to the N^{th} stage of working circuit 100A_{N}, and the first stage of working circuit 100A₁ is used to send the working circuit signal to the control board 20. That is to say, the signal transmission direction of the N stages of working circuits 100 is from A_{N} to A₁.

In this embodiment, the signal voltage conversion circuit can enable parallel transmission of control board signals and working circuit signals between the N stages of working circuits 100 and the control board 20, thereby improving working efficiency.

It should be noted that the signal voltage conversion circuit may transmit one or more signals. That is to say, the signal voltage conversion circuit can enable parallel transmission of multiple channels of control board signals and working circuit signals with different waveforms.

Of course, the present application is not limited thereto. In another implementation, the signal voltage conversion circuit is used to send working circuit signals sent by the N stages of working circuits 100 to the control board 20. Specifically, the control board 20 sends its own control board signal to the N stages of working circuits 100; the N stages of working circuits 100 work according to the control board signal, and generates a working circuit signal according to the final working result, and then sends the working circuit signal to the signal voltage conversion circuit; the signal voltage conversion circuit performs voltage conversion on the working circuit signal and then sends the converted working circuit signal to the control board 20.

The working circuit signal may be a data signal such as a calculation result, and the control board signal may be a data signal such as a data source. For example, the N stages of working circuits 100 calculate or operate on a data source in the control board signal to obtain a calculation result.

By way of example, the first stage of working circuit 100A₁ is used to receive the control board signal from the control board 20, and the signal voltage conversion circuit is used to send the working circuit signal of the N^{th} stage of working circuit 100A_{N} to the control board 20. That is to say, the direction in which signals of the N stages of working circuits 100 are transmitted is from A₁ to A_{N}.

In one implementation, as shown in FIGS. 2A-4, the working chips 110 each include a plurality of power supply domains, and the signal transmission power supply circuit 400 includes a plurality of sub-power supply transmission circuits, which are connected between the power supply chip 410 and the working chip 110 and between a plurality of power supply domains of the same working chip 110, respectively, wherein the sub-power supply transmission circuits connected between the plurality of power supply domains of the same working chip 110 are located inside and outside of the corresponding working chip 110. That is to say, the plurality of power supply domains can be connected internally or externally to the working chip 110, so as to enable signal transmission while selecting the way in which the power supply domains are connected according to actual needs.

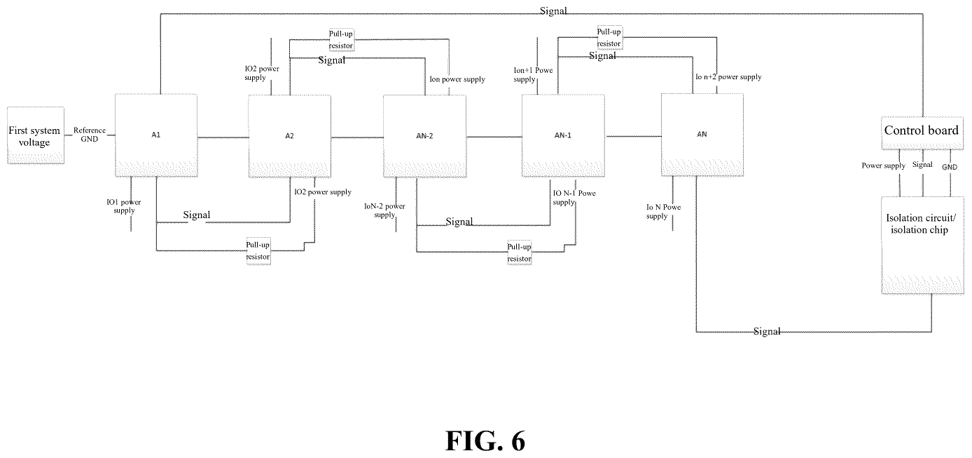

FIG. 6 shows a circuit diagram of a signal transmission circuit 10 according to an embodiment of the second aspect of the present application. As shown in FIG. 6, the signal transmission circuit 10 includes N stages of working circuits 100 connected in series, N stages of signal transmission power supply circuits 400, and pull-up resistors 500. For ease of description, as shown in FIG. 6, the N stages of working circuits 100 are numbered A₁, A₂, A₃, . . . , A_{N-1}, and A_{N}, respectively, wherein N is an integer greater than 1.

The working circuits 100 each include at least one working chip 110. The working chip 110 may be various computing chips or control chips, etc., to realize corresponding core functions such as computing functions or control functions. In the case where a plurality of working chips 110 are included in the same stage of working circuit 100, the plurality of working chips 110 may be connected in parallel.

Optionally, the number of working chips 110 in the stages of working circuits 100 may be equal or not equal. It can be understood that the number of working chips 110 in the stages of working circuits 100 can be specifically configured according to actual needs to better meet practical applications.

The pull-up resistors 500 is connected in series between two adjacent stages of working circuits 100 and are configured to convert a first high-level voltage outputted by the i^{th} stage of working circuit 100 into a second high-level voltage inputted by the (i+1)^{th} stage of working circuit 100, wherein the second high-level voltage is higher than the first high-level voltage, and i is a positive integer greater than or equal to 1 and less than or equal to N-1.

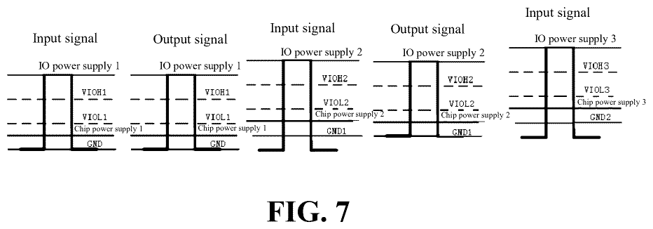

By way of example, as shown in FIG. 7, when the stage voltage outputted by the first stage of working circuit 100 is 0, the corresponding stage voltage inputted by the second stage of working circuit 100 is 0; when the first high level voltage outputted by the first stage of working circuit 100 is z, the first high level voltage is converted into a second high level voltage through a pull-up resistor 500 located between the first stage of working circuit 100 and the second stage of working circuit 100, so that the IO power supply 2 is at a high level, wherein z corresponds to the high level output. Similarly, when the stage voltage outputted by the second stage of working circuit 100 is 0, the corresponding stage voltage inputted by the third stage of working circuit 100 is 0; when the second high level voltage outputted by the first stage of working circuit 100 is z, the first high level voltage is converted into a second high level voltage through a pull-up resistor 500 located between the second stage of working circuit 100 and the third stage of working circuit 100, so that the IO power supply 3 is at a high level. The pull-up resistors 500 can be selected with different values based on the driving current.

In one implementation, the third high level voltage outputted by the i^{th} stage of working circuit 100 is equal to the second high level voltage inputted by the i^{th} stage of working circuit 100. For example, in the example of FIG. 7, the input signal high level and the output signal high level of the same stage of working circuit 100 are consistent. Specifically, the high level voltage outputted by the first stage of working circuit 100 is equal to the high level voltage inputted by the first stage of working circuit 100. The high level voltage outputted by the second stage of working circuit 100 is equal to the high level voltage inputted by the second stage of working circuit 100, and the high level voltage inputted by the second stage of working circuit 100 may be greater than the high level voltage outputted by the first stage of working circuit 100. Similarly, the high level voltage outputted by the third stage of working circuit 100 is equal to the high level voltage inputted by the third stage of working circuit 100, and the high level voltage outputted by the third stage of working circuit 100 may be greater than the high level voltage outputted by the second stage of working circuit 100.

In one implementation, as shown in FIG. 7, a first low level voltage outputted by the i^{th} stage of working circuit 100 is equal to a second low level voltage inputted by the (i+1)^{th} stage of working circuit 100, and a second low level voltage outputted by the (i+1)^{th} stage of working circuit is greater than the second low level voltage inputted by the (i+1)^{th} stage of working circuit 100. For example, in the example of FIG. 7, the signal low level outputted by the previous one stage of working circuit 100 is consistent with the signal low level inputted by the next one stage of working circuit 100. Specifically, the signal high level inputted by the same stage of working circuit consistent with the signal high level outputted by the same stage of working circuit. The low level voltage outputted by the first stage of working circuit 100 is equal to the low level voltage inputted by the second stage of working circuit 100. The low level voltage outputted by the second stage of working circuit 100 is equal to the low level voltage inputted by the third stage of working circuit 100. Moreover, the low level voltage outputted by the second stage of working circuit 100 may be greater than the low level voltage inputted by the second stage of working circuit 100.

In one implementation, a minimum difference between the second high level voltage and a corresponding threshold voltage is greater than 0 V. For example, in the example of FIG. 7, the threshold high voltage corresponding to the second stage of working circuit 100 is VIOH2, the threshold low voltage is VIOL2, the core working voltage is chip power supply 2, and the reference voltage is GND2. The second high level voltage is IO power supply 2, and the minimum difference between IO power supply 2 and the corresponding threshold voltage is the difference between IO power supply 2 and the high threshold voltage VIOH2. That is, the difference between the IO power supply 2 and the threshold high voltage VIOH2 is greater than 0 V.

In one implementation, working chips 110 in the same stage of working circuit 100 have the same reference voltage, and working chips 110 in two adjacent stages of working circuits 100 have different reference voltages.

Reference voltages of the working chips 110 in the (i+1)^{th} stage of working circuit 100 are all derived from the i^{th} stage of working circuit 100, wherein i is an integer greater than or equal to 1. For example, reference voltages of the working chips 110 in the second stage of working circuit 100 are all derived from the first stage of working circuit 100, reference voltages of the working chips 110 in the third stage of working circuit 100 are all derived from the second stage of working circuit 100, . . . , reference voltages of the working chips 110 in the N^{th} stage of working circuit 100 are all derived from the (N-1)^{th} stage of working circuit 100. Reference voltages of the working chips 110 in the first stage of working circuit 100 can be derived from the first system voltage 200. A first reference voltage outputted by the i^{th} stage of working circuit may be less than a second reference voltage inputted by the (i+1)^{th} stage of working circuit. Or a difference between the first high level voltage and a corresponding first reference voltage is equal to a difference between the second high level voltage and a corresponding second reference voltage. The “equal” here should be understood in a broad sense, meaning that the difference between the first high level voltage and the corresponding first reference voltage and the difference between the second high level voltage and the corresponding second reference voltage are equal within a certain error range, but are not limited to being completely equal.

In one implementation, the signal transmission circuit 10 further includes a signal voltage conversion circuit, wherein a first input/output terminal of the signal voltage conversion circuit is connected to the N^{th} stage of working circuit, a second input/output terminal of the signal voltage conversion circuit is connected to the control board, and the signal voltage conversion circuit is configured to perform voltage conversion on a control board signal sent by the control board and send the converted control board signal to the N^{th} stage of working circuit 100; or the signal voltage conversion circuit is configured to perform voltage conversion on a working circuit signal sent by the N^{th} stage of working circuit and send the converted working circuit signal to the control board. As such, in this embodiment, the signal voltage conversion circuit can enable parallel transmission of control board signals and working circuit signals between the N stages of working circuits 100 and the control board 20, thereby improving working efficiency.

In one implementation, the first stage of working circuit 100 is configured to receive the control board signal, and the signal voltage conversion circuit is configured to send the working circuit signal of the N^{th} stage of working circuit 100 to the control board.

A circuit board according to the embodiments of the third aspect of the present application including the signal transmission circuit 10 according to any one of the implementations of the first aspect or the second aspect of the present application.

By way of example, the circuit board may include a substrate, a first system voltage 200 interface, and a second system voltage 300 interface, wherein the first system voltage 200 interface and the second system voltage 300 interface are used to connect to the system power supply and the system ground terminal, respectively, to provide the first system voltage 200 and the second system voltage 300, respectively. The signal transmission circuit 10 described above is arranged on the substrate. The circuit board can be a computing circuit board, also called a hashrate board, which meets the computing power requirements in fields such as artificial intelligence and big data.

An electronic device according to the embodiments of the fourth aspect of the present application including a circuit board according to the embodiments of the third aspect of the present application. By way of example, the electronic device may be a computing device applied in high-computation scenarios in fields such as artificial intelligence and big data.

Other components of the circuit board or electronic device in the above embodiments may be implemented using any technical solutions known or hereafter developed by a person of ordinary skill in the art, which are not described in detail herein.

In the description of the present specification, It can be appreciated that orientations or positional relationships indicated by terms such as “central”, “longitudinal”, “lateral”, “length”, “width”, “thickness”, “up”, “down”, “front”, “back”, “left”, “right”, “vertical”, “horizontal”, “top”, “bottom”, “inside”, “outside”, “clockwise”, “counterclockwise”, “axial”, “radial”, “circumferential” and the like are orientations or positional relationships based on the drawings, which are only for the convenience of describing the present application and simplifying the description, and do not indicate or imply that the referred device or element must have a specific orientation, be constructed and operated in a specific orientation, and therefore should not be understood as a limitation on the present application.

In addition, terms such as “first” and “second” are used for descriptive purposes only and cannot be understood as indicating or implying relative importance or implicitly indicating the quantity of the indicated technical features. Therefore, a feature defined as “first” or “second” may explicitly or implicitly include one or more of the features. In the description of the present application, “a/the plurality of” means two or more than two, unless otherwise clearly and specifically defined.

In the present application, unless otherwise clearly specified and limited, terms such as “mount”, “link”, “connect”, “fix”, etc. and variants thereof should be understood in a broad sense. For example, it may be a fixed connection, or may be a detachable connection, or formed into one piece. It may be a mechanical connection, an electrical connection, or a communication connection. It may be a direct connection or an indirect connection through an intermediate medium. It may be an internal communication between two elements or an interaction relationship between two elements. For those of ordinary skill in the art, the specific meanings of the above terms in the present application may be understood according to specific circumstances.

In the present application, unless otherwise clearly specified and limited, a first feature being “on” or “under” a second feature may include the first and second features being in direct contact, or may include the first and second features not being in direct contact but being in contact through another feature between them. Moreover, a first feature being “over”, “above”, or “onto” a second feature includes the first feature being directly above or obliquely above the second feature, or simply means that the first feature is at a higher horizontal stage than the second feature. A first feature being “under”, “below”, or “beneath” a second feature includes the first feature being directly below or diagonally below the second feature, or simply means that the first feature is at a lower horizontal stage than the second feature.

The above disclosure provides many different embodiments or examples for implementing different structures of the present application. In order to simplify the disclosure of the present application, components and arrangements of specific examples are described above. Of course, they are merely examples and are not intended to limit the present application. In addition, the present application may repeat reference numerals and/or reference letters in different examples. Such repetition is for the purpose of simplicity and clarity, which is not aimed to indicate relationships between various embodiments and/or arrangements discussed.

The above are only detailed description of the present application, the protection scope of the present application is not limited thereto. Any technician familiar with the technical field may easily conceive of various changes or substitutions within the technical scope disclosed in the present application, which should all be encompassed in the protection scope of the present application. Therefore, the protection scope of the present application should be based on the protection scope of the claims.

1. A signal transmission circuit, characterized by comprising:
N stages of working circuits connected in series, each comprising at least one working chip, wherein a first stage of working circuit is connected to a first system voltage, an N^{th} stage of working circuit is connected to a second system voltage, the second system voltage is higher than the first system voltage, and a voltage difference between the second system voltage and the first system voltage provides a core working voltage for each stage of working circuit; and
N stages of signal transmission power supply circuits corresponding one-to-one to the N stages of working circuits, wherein the signal transmission power supply circuits each comprises at least one power supply chip, and is configured to provide a signal transmission voltage for the working chip in the at least one working circuits, wherein N is an integer greater than 1.

2. The signal transmission circuit as claimed in claim 1, characterized in that a high voltage of signal transmission inputted by the working chip is greater than a threshold high voltage, a low voltage of signal transmission inputted by the working chip is less than a threshold low voltage, and the core working voltage of the working chip is less than a difference between the signal transmission voltage and the threshold high voltage.

3. The signal transmission circuit as claimed in claim 1, characterized in that the working chip comprises at least one power supply domain for providing power supply for signal transmission to the working chip.

4. The signal transmission circuit as claimed in claim 1, characterized in that the N stages of working circuits comprise at least one first working chip, the first working chip comprises a first power supply domain and a second power supply domain, and the signal transmission voltage inputted by the first power supply domain of the first working chip and the signal transmission voltage inputted by the second power supply domain are both provided by the same signal transmission power supply circuit,
the first power supply domain and the second power supply domain of the first working chip are connected inside and outside of the first working chip through a transmission line, and
all of the working chips in the N stages of working circuits are configured as first working chips.

5. (canceled)

6. (canceled)

7. The signal transmission circuit as claimed in claim 4, characterized in that the N stages of working circuits further comprise at least one second working chip, the second working chip comprises a third power supply domain and a fourth power supply domain, and the signal transmission voltage inputted by the third power supply domain of the second working chip and the signal transmission voltage inputted by the fourth power supply domain are provided by different signal transmission power supply circuits.

8. The signal transmission circuit as claimed in claim 7, characterized in that the signal transmission voltage inputted by the third power supply domain of the second working chip is provided by a previous one stage of signal transmission power supply circuit, and the signal transmission voltage inputted by the fourth power supply domain of the second working chip is provided by a corresponding stage of signal transmission power supply circuit.

9. The signal transmission circuit as claimed in claim 7, characterized in that working chips in the first stage of working circuit are all configured as first working chips, and second to N^{th} stages of working circuits each comprises at least one first working chip and at least one second working chip.

10. The signal transmission circuit as claimed in claim 1, wherein working chips in the same stage of working circuit have the same reference voltage, and working chips in two adjacent stages of working circuits have different reference voltages, and
a reference voltage of each working chip in (i+1)^{th} stage of working circuit are all derived from i^{th} stage of working circuit, wherein i is an integer greater than or equal to 1.

11. (canceled)

12. The signal transmission circuit as claimed in claim 10, characterized in that a low level voltage outputted by the i^{th} stage of working circuit is equal to a low level voltage inputted by the (i+1)^{th} stage of working circuit, and a low level voltage outputted by the (i+1)^{th} stage of working circuit is greater than the low level voltage inputted by the (i+1)^{th} stage of working circuit; and
a high level voltage inputted by the i^{th} stage of working circuit is equal to a high level voltage inputted by the (i+1)^{th} stage of working circuit, and a high level voltage outputted by the (i+1)^{th} stage of working circuit is greater than the high level voltage inputted by the (i+1)^{th} stage of working circuit.

13. The signal transmission circuit as claimed in claim 1, characterized by further comprising:
a signal voltage conversion circuit configured to send a control board signal sent by a control board to the N stages of working circuits or send working circuit signals sent by the N stages of working circuits to the control board.

14. The signal transmission circuit as claimed in claim 13, characterized in that the first stage of working circuit is configured to receive the control board signal, and the signal voltage conversion circuit is configured to send a working circuit signal of the N^{th} stage of working circuit to the control board.

15. The signal transmission circuit as claimed in claim 1, characterized by further comprising:
pull-up resistors connected in series between two adjacent stages of working circuits and configured to convert a first high-level voltage outputted by the i^{th} stage of working circuit into a second high-level voltage inputted by the (i+1)^{th} stage of working circuit, wherein the second high-level voltage is higher than the first high-level voltage, and i is a positive integer greater than or equal to 1 and less than or equal to N-1.

16. The signal transmission circuit as claimed in claim 15, characterized in that a third high level voltage outputted by the (i+1)^{th} stage of working circuit is equal to the second high level voltage inputted by the (i+1)^{th} stage of working circuit.

17. The signal transmission circuit as claimed in claim 15, characterized in that a first low level voltage outputted by the i^{th} stage of working circuit is equal to a second low level voltage inputted by the (i+1)^{th} stage of working circuit, and a second low level voltage outputted by the (i+1)^{th} stage of working circuit is greater than the second low level voltage inputted by the (i+1)^{th} stage of working circuit.

18. The signal transmission circuit as claimed in claim 15, characterized in that working chips in the same stage of working circuit have the same reference voltage, and working chips in two adjacent stages of working circuits have different reference voltages,
a first reference voltage outputted by the i^{th} stage of working circuit is less than a second reference voltage inputted by the (i+1)^{th} stage of working circuit, and
a difference between the first high level voltage and a corresponding first reference voltage is equal to a difference between the second high level voltage and a corresponding second reference voltage.

19. (canceled)

20. (canceled)

21. The signal transmission circuit as claimed in claim 15, characterized in that reference voltages of each working chip in the (i+1)^{th} stage of working circuit are all derived from the i^{th} stage of working circuit, and reference voltages of each working chip in the first stage of working circuit are derived from the first system voltage.

22. The signal transmission circuit as claimed in claim 1, characterized by further comprising:
a signal voltage conversion circuit, wherein a first input/output terminals of the signal voltage conversion circuit is connected to the N^{th} stage of working circuit, a second input/output terminals of the signal voltage conversion circuit is connected to a control board, and the signal voltage conversion circuit is configured to perform voltage conversion on a control board signal sent by the control board and then send the converted control board signal to the N^{th} stage of working circuit; or the signal voltage conversion circuit is configured to perform voltage conversion on a working circuit signal sent by the N^{th} stage of working circuit and then send the converted working circuit signal to the control board.

23. The signal transmission circuit as claimed in claim 22, characterized in that the first stage of working circuit is configured to receive the control board signal, and the signal voltage conversion circuit is configured to send the working circuit signal of the N^{th} stage of working circuit to the control board.

24. A circuit board, characterized by comprising the signal transmission circuit as claimed in claim 1.

25. An electronic device, characterized by comprising the circuit board as claimed in claim 24.
